(19) United States
(12) Patent Application Publication
(10) Pub. No.: US 2025/0100527 A1
(43) Pub. Date: Mar. 27, 2025

(54) WHEEL-SPECIFIC BRAKE UNIT AND BRAKE SYSTEM FOR A VEHICLE

(71) Applicant: Robert Bosch GmbH, Stuttgart (DE)

(72) Inventor: Matthias Greiner, Simmozheim (DE)

(21) Appl. No.: 18/730,849

(22) PCT Filed: Feb. 6, 2023
(86) PCT No.: PCT/EP2023/052846

§ 371 Date: Jul. 22, 2024

(30) Foreign Application Priority Data
Feb. 11, 2022 (DE) 10 2022 201 451.0

(51) Int. Cl. B60T 13/68; B60T 13/74

(52) U.S. Cl. CPC B60T 13/686; B60T 13/745; B60Y 2400/81

(57) ABSTRACT

A wheel-specific brake unit for a vehicle. The wheel-specific brake unit including a single wheel brake cylinder, a motorized piston-cylinder device with an electric motor and at least one piston adjustable by means of an operation of the electric motor, and at least one hydraulic line via which the wheel brake cylinder is hydraulically connected to the motorized piston-cylinder device in such a way that brake fluid is transferable between the motorized piston-cylinder device and the wheel brake cylinder by means of the at least one adjusted piston of the motorized piston-cylinder device. A brake system for a vehicle, and a method for mounting a wheel-specific brake unit are also described.

### FIELD

The present invention relates to a wheel-specific brake unit for a vehicle. The present invention also relates to a brake system for a vehicle. Furthermore, the present invention relates to a method for mounting a wheel-specific brake unit.

### BACKGROUND INFORMATION

Electromechanical brake devices for motor vehicles are described in the related art including, for example, German Patent Application No. DE 10 2019 219 002 A1.

### SUMMARY

The present invention provides a wheel-specific brake unit for a vehicle, a brake system for a vehicle, and a method for mounting a wheel-specific brake unit.

The present invention provides a wheel-specific brake unit, or a brake system equipped therewith, wherein the wheel-specific brake unit according to the present invention has a more cost-effective design in comparison to a conventional electromechanical brake device and is easier to install on a wheel of a vehicle/motor vehicle. Due to the wheel-specific brake unit according to the present invention being equipped with its at least one hydraulic line, installing the motorized piston-cylinder device, in particular its electric motor, directly on the respective wheel is unnecessary. The design of the wheel-specific brake unit according to the present invention thus ensures greater flexibility in the installation of the motorized piston-cylinder device, in particular its electric motor, in such a way that the motorized piston-cylinder device/its electric motor is reliably protected from environmental influences, such as impacts, splash water and a hot brake disk. The wheel-specific brake unit according to the present invention, or the brake system formed therewith, therefore has an increased service life in comparison to a conventional electromechanical brake device and requires repair more rarely.

In an advantageous embodiment of the wheel-specific brake unit of the present invention, a maximum receiving volume of the motorized piston-cylinder device is less than or equal to 8 cm³. The maximum receiving volume is understood to mean the volume of brake fluid that can at most be sucked into at least one internal volume of the motorized piston-cylinder device that is limited by its at least one adjustable piston. Due to the comparatively small maximum receiving volume of the motorized piston-cylinder device of at most 8 cm³, the embodiment described here of the wheel-specific brake unit can be produced comparatively cost-effectively and installed relatively simply on the particular vehicle.

According to an example embodiment of the present invention, alternatively, or additionally, a maximum travel path of the at least one piston of the motorized piston-cylinder device that is adjustable by means of an operation of the electric motor may in each case be less than or equal to 80 mm. This facilitates miniaturization of the motorized piston-cylinder device or of the embodiment described here of the wheel-specific brake unit. In addition, limiting the maximum travel path of the at least one adjustable piston of the motorized piston-cylinder device to at most 80 mm reduces the requirements for an electric motor suitable for the operation of the motorized piston-cylinder device. This also helps reduce the production costs of the wheel-specific brake unit.

In another advantageous embodiment of the present invention, the wheel-specific brake unit comprises a printed circuit board designed and/or programmed to control operation of the electric motor arranged at and/or on the printed circuit board. Due to the wheel-specific brake unit being equipped with its at least one hydraulic line, the printed circuit board can also be installed in a relatively well protected position on the vehicle equipped with the embodiment described here of the wheel-specific brake unit.

As an advantageous development of the present invention, the wheel-specific brake unit can comprise a wheel inlet valve, which is arranged in the at least one hydraulic line in such a way that, by means of the wheel inlet valve present in its closed state, a transfer of brake fluid from the motorized piston-cylinder device into the wheel brake cylinder is prevented. In this case, a brake pressure build-up in the wheel brake cylinder can also be controlled by means of the wheel inlet valve.

According to an example embodiment of the present invention, alternatively, or additionally, the wheel-specific brake unit may also comprise a brake fluid reservoir, and the motorized piston-cylinder device may be hydraulically connected to the brake fluid reservoir in such a way that brake fluid from the brake fluid reservoir can be sucked into the motorized piston-cylinder device. The brake fluid reservoir can thus be used to “refill” brake fluid into the motorized piston-cylinder device.

Likewise, according to an example embodiment of the present invention, the wheel-specific brake unit can also comprise a wheel outlet valve arranged in at least one return line in such a way that, by means of the wheel outlet valve present in its closed state, a transfer of brake fluid from the wheel brake cylinder via the at least one return line into the brake fluid reservoir is prevented. By switching the wheel outlet valve, locking of a wheel braked by means of the wheel brake cylinder of the embodiment described here of the wheel-specific brake unit can thus be released.

A brake system for a vehicle with at least one wheel-specific brake unit also ensures the advantages described above. The brake system can in particular be equipped as a decentralized brake system with a wheel-specific brake unit per wheel of the particular vehicle. In this case, each wheel of the vehicle can be braked individually by means of a pressure actuation in the wheel brake cylinder arranged on the wheel.

In one advantageous embodiment of the brake system of the present invention, a control device, to which the at least one wheel-specific brake unit is electrically connected, is designed and/or programmed, by taking into account at least one braking request signal provided to the control device by at least one brake actuation element sensor and/or by at least one vehicle speed control mechanism, to output at least one control signal to the respective electric motor or to the respective printed circuit board of the at least one wheel-specific brake unit. A pressure actuation in the respective wheel brake cylinder of the at least one wheel-specific brake unit can thus take place by a driver of the particular vehicle or according to the vehicle speed control mechanism in a manner corresponding to an actuation of a brake actuation element that is detected by means of the at least one brake actuation element sensor.

Preferably, according to an example embodiment of the present invention, the brake system comprises a plurality of the wheel-specific brake units, wherein each of the wheel-specific brake units is hydraulically separate from the other wheel-specific brake units. The wheel-specific brake units being hydraulically separate from one another can be understood to mean that the wheel-specific brake units are connected to one another at most via their electrical connection to the control device of the brake system and/or via at least one signal and/or bus line. The wheel-specific brake units being hydraulically separate from one another thus ensures that, in the case of leakage in a wheel-specific brake unit, the other wheel-specific brake units of the brake system are still fully functional.

Furthermore, according to an example embodiment of the present invention, a method for mounting a wheel-specific brake unit on a vehicle is also advantageous, during which the following steps are performed: mounting the wheel brake cylinder of the wheel-specific brake unit on a wheel of the vehicle and mounting the motorized piston-cylinder device of the wheel-specific brake unit on a spring-loaded region of the vehicle with respect to the wheel. The mounting of the wheel-specific brake unit on the particular vehicle by performing the method described here ensures in particular that the motorized piston-cylinder device is protected from mechanical impacts, splash water and a hot brake disk.

### BRIEF DESCRIPTION OF THE DRAWINGS

Further features and advantages of the present invention are explained below with reference to the figures.

FIG. 1 shows a schematic illustration of a first embodiment of the wheel-specific brake unit, or the brake system equipped therewith, according to the present invention.

FIG. 2 shows a schematic illustration of a second embodiment of the wheel-specific brake unit, or the brake system equipped therewith, according to the present invention.

FIG. 3 shows a schematic illustration of a third embodiment of the wheel-specific brake unit, or the brake system equipped therewith, according to an example embodiment of the present invention.

FIG. 4 shows a flowchart for explaining an embodiment of the method for mounting a wheel-specific brake unit on a vehicle, according to the present invention.

### DETAILED DESCRIPTION OF EXAMPLE EMBODIMENTS

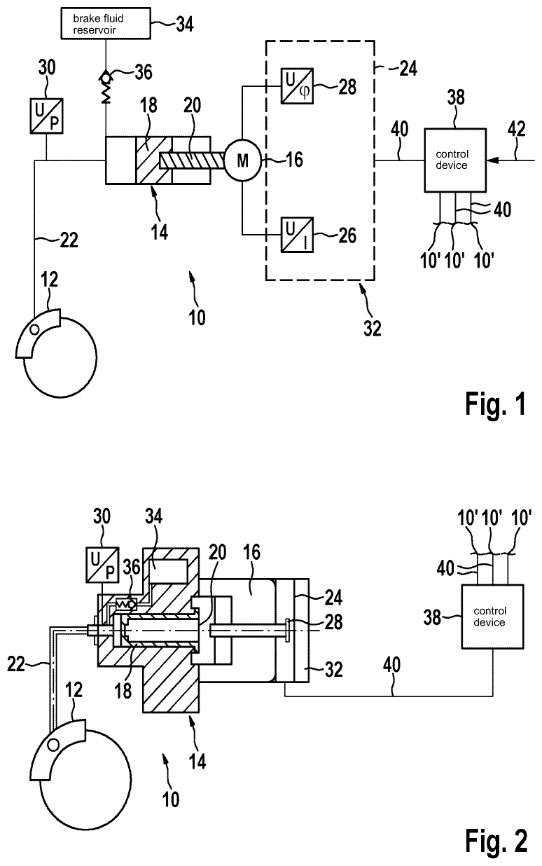

FIG. 1 shows a schematic illustration of a first embodiment of the wheel-specific brake unit, or the brake system equipped therewith.

The wheel-specific brake unit 10, or the brake system equipped therewith, shown schematically in FIG. 1 is mountable/mounted on a vehicle/motor vehicle. It is explicitly pointed out that usability of the wheel-specific brake unit 10 is not limited to a specific vehicle type/motor vehicle type. In particular, the usability of the wheel-specific brake unit 10 is not limited to a certain number of wheels of the vehicle/motor vehicle. The brake system realized by means of the at least one wheel-specific brake unit 10 can also be simply adapted to vehicle types/motor vehicle types with different numbers of wheels.

The wheel-specific brake unit 10 only has a single wheel brake cylinder 12, which is mountable/mounted on a wheel of the particular vehicle/motor vehicle. The wheel with the wheel brake cylinder 12 mounted thereon can optionally be a front wheel, a rear wheel, or a further wheel of the vehicle/motor vehicle that is arranged between the at least one front wheel and the at least one rear wheel. In addition, the wheel-specific brake unit 10 comprises a motorized piston-cylinder device 14 with an electric motor 16 and at least one piston 18 adjustable by means of an operation of the electric motor 16. The motorized piston-cylinder device 14 can also be referred to as a plunger device. Preferably, the electric motor 16 is connected to the at least one adjustable piston 18 via a threaded device 20 of the motorized piston-cylinder device 14 in such a way that the at least one piston 18 is linearly adjustable/adjusted by means of the operation of the electric motor 16 within at least one internal volume of the motorized piston-cylinder device 14. The threaded device 20 may, for example, comprise a planetary gear train and/or a spindle, such as in particular a ball screw. However, it is pointed out that formability of the motorized piston-cylinder device 14 is not limited to a particular type of thread.

The wheel brake cylinder 12 is hydraulically connected to the motorized piston-cylinder device 14 via at least one hydraulic line 22 such that brake fluid is transferable/transferred between the at least one internal volume of the motorized piston-cylinder device 14 and the wheel brake cylinder 12 by means of the at least one adjusted piston 18 of the motorized piston-cylinder device 14. By means of the operation of the electric motor 16 of the motorized piston-cylinder device 14, a brake pressure present in the wheel brake cylinder 12 can thus be set in a wheel-specific manner. In this way, a braking force applied to the wheel equipped with the wheel brake cylinder 12 can be selected in a wheel-specific manner.

The at least one hydraulic line 22 via which the brake fluid transfer takes place between the at least one internal volume of the motorized piston-cylinder device 14 and the wheel brake cylinder 12 can be relatively short. Nevertheless, equipping the wheel-specific brake unit 10 with its at least one hydraulic line 22 makes it possible to arrange the motorized piston-cylinder device 14 spaced apart from the wheel brake cylinder 12. While the wheel brake cylinder 12 is mounted directly on the wheel of the vehicle/motor vehicle that is braked thereby, the motorized piston-cylinder device 14 can still be arranged at a position of the vehicle/motor vehicle at which it is protected from environmental influences, such as splash water and a hot brake disk of the wheel. Equipping the wheel-specific brake unit 10 with its at least one hydraulic line 22 therefore realizes increased flexibility in the mounting of the motorized piston-cylinder device 14 on the vehicle/motor vehicle and improved protection of the mounted motorized piston-cylinder device 14 from environmental influences.

It is expressly pointed out that no second wheel brake cylinder is additionally hydraulically connected to the motorized piston-cylinder device 14. If, in addition to the wheel brake cylinder 12 of the wheel-specific brake unit 10 described here, the brake system explained in more detail below also comprises at least one further wheel brake cylinder of at least one further wheel-specific brake unit 10′, the at least one further wheel brake cylinder is hydraulically separate from the motorized piston-cylinder device 14 of the wheel-specific brake unit 10 described here. The motorized piston-cylinder device 14 being hydraulically separate from the at least one further wheel brake cylinder is understood to mean that there is no hydraulic line between the motorized piston-cylinder device 14 and the at least one further wheel brake cylinder.

The electric motor 16 of the motorized piston-cylinder device 14 can be operated by means of a printed circuit board (PCB) 24, which is designed and/or programmed accordingly. The electric motor 16 can be arranged at and/or on the printed circuit board 24. Preferably, especially a power stage (electronic driver module) of the electric motor 16, such as a B6 driver bridge of the electric motor 16, is integrated in the printed circuit board 24. Optionally, the electric motor 16 can also be equipped with a motor current sensor 26 and/or with a rotor position sensor or rotation rate sensor 28. In this case, the motor current sensor 26 and/or the rotor position sensor or rotation rate sensor 28 of the electric motor 16 can be read by means of the printed circuit board 24. For example, a magnet wheel of the rotor position sensor or rotation rate sensor 28 can be mounted on a shaft of the electric motor 16, while an application-specific circuit on the printed circuit board 24 ascertains the position of the magnet wheel and thus the position of the rotor of the electric motor 16 or the rotation rate of the electric motor 16. A pressure signal of a pressure sensor 30 hydraulically connected to the at least one hydraulic line 22 can also be evaluated by the printed circuit board 24. The printed circuit board 24 can be part of an electrical control unit (ECU) 32, which is fastened to the electric motor 16. Optionally, the wheel-specific brake unit 10 may also comprise a brake fluid reservoir 34. In this case, the motorized piston-cylinder device 14 can be hydraulically connected to the brake fluid reservoir 34 in such a way that brake fluid from the brake fluid reservoir 34 can be sucked/“refilled” into the motorized piston-cylinder device 14. Since a volume stored in the brake fluid reservoir 34 is only needed for a pressure build-up in the single wheel brake cylinder 12, the brake fluid reservoir 34 can be designed to have a comparatively small volume. Preferably, the motorized piston-cylinder device 14 is hydraulically connected to the brake fluid reservoir 34 via a pressure relief valve 36 in such a way that, only in the case of a “lack” of volume in the motorized piston-cylinder device 14, brake fluid flows from the brake fluid reservoir via the pressure relief valve 36 into the at least one internal volume of the motorized piston-cylinder device 14. It is also pointed out here that equipping the wheel-specific brake unit 10 with the brake fluid reservoir 34 and, where appropriate, also with the pressure relief valve 36 can often be dispensed with.

In the embodiment of FIG. 1, the wheel-specific brake unit 10 is part of a brake system for the particular vehicle/motor vehicle. In addition to the wheel-specific brake unit 10, the brake system can also comprise at least one further wheel-specific brake unit 10′, which has the same design as the wheel-specific brake unit 10 described above. The design, depicted in FIG. 1, of the brake system with exactly four wheel-specific brake units 10 and 10′ for a motor vehicle with exactly four wheels is to be interpreted only by way of example.

The brake system also comprises a control device 38, to which the at least one wheel-specific brake unit 10 and 10′ is electrically connected. The control device 38 is designed and/or programmed to output at least one control signal to the respective electric motor 16 or to the respective printed circuit board 24 of the at least one wheel-specific brake unit 10 and 10′. For this purpose, the control device 38 can be connected via at least one signal and/or bus line 40 to its at least one wheel-specific brake unit 10 and 10′. Since the at least one signal and/or bus line 40 can be easily laid in comparison to a hydraulic line, the electrical connection of the at least one wheel-specific brake unit 10 and 10′ to the control device 38 is not associated with a substantial amount of work.

The at least one control signal is preferably output taking into account at least one brake request signal 42 provided to the control device 38. The at least one brake request signal 42 can optionally be provided to the control device 38 by at least one brake actuation element sensor or by at least one vehicle speed control mechanism. The at least one brake actuation element sensor is understood to mean a type of sensor by means of which an actuation of a brake actuation element of the vehicle/motor vehicle, such as a brake pedal, is detectable. The at least one brake actuation element sensor may, for example, be a rod travel sensor and/or a differential travel sensor. The at least one vehicle speed control mechanism is designed to autonomously/automatically control the speed of the vehicle/motor vehicle. The at least one vehicle speed control mechanism may, for example, be a driver assistance system, such as an adaptive cruise control (ACC), and/or an emergency brake system.

If the brake system comprises a plurality of the wheel-specific brake units 10 and 10′, each of the wheel-specific brake units 10 and 10′ is hydraulically separate from the at least one other wheel-specific brake unit 10 and 10′. This is understood to mean that the wheel-specific brake units 10 and 10′ are connected to one another at most via their signal and/or bus lines 40, the control device 38, and/or via at least one further signal and/or bus line (not shown). In particular, no hydraulic line extends from one of the wheel-specific brake units 10 and 10′ to the at least one other wheel-specific brake unit 10 and 10′. Since the wheel-specific brake units 10 and 10′ are hydraulically separate, the conventionally required hydraulic lines between the wheels braked by the wheel-specific brake units 10 and 10′ are omitted in the brake system of FIG. 1. The brake system thus has a very compact and space-saving structure. In particular, a modular structure of the brake system is realized at comparatively low production costs. The wheel-specific brake units 10 and 10′ can also be mounted on the vehicle as separate units. This also facilitates mounting of the brake system described here.

FIG. 2 shows a schematic illustration of a second embodiment of the wheel-specific brake unit, or the brake system equipped therewith.

In contrast to the above-explained embodiment, in the brake system of FIG. 2, the power stage (electronic driver module) of the respective electric motor 16 of its at least one wheel-specific brake unit 10 and 10′, specifically the at least one B6 driver bridge of the respective electric motor 16 of its at least one wheel-specific brake unit 10 and 10′, is integrated in the electronics of the control device 38 of the brake system. This facilitates miniaturization of the at least one wheel-specific brake unit 10 and 10′ of the brake system. The relatively low currents, which are sufficient to operate the respective electric motor 16 of the at least one wheel-specific brake unit 10 and 10′, can be provided by the control device 38 to the respective electric motor 16 or its printed circuit board 24.

With respect to further features and properties of the embodiment of FIG. 2 and their advantages, reference is made to the description of FIG. 1 above.

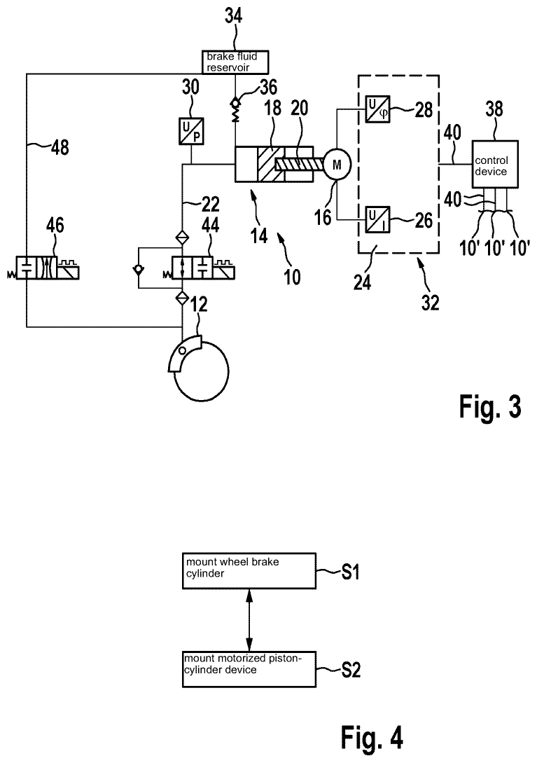

FIG. 3 shows a schematic illustration of a third embodiment of the wheel-specific brake unit and/or of the brake system equipped therewith.

The wheel-specific brake unit 10 shown schematically in FIG. 3 also comprises a wheel inlet valve 44 and a wheel outlet valve 46 as a development to the embodiment of FIG. 1. The wheel inlet valve 44 is arranged in the at least one hydraulic line 22 in such a way that, by means of the wheel inlet valve 44 present in its closed state, a transfer of brake fluid from the motorized piston-cylinder device 14 into the wheel brake cylinder 12 is prevented. The brake pressure present in the wheel brake cylinder 12 can thus also be set to a preferred value by switching the wheel inlet valve 44.

The wheel outlet valve 46 is arranged in at least one return line 48 of the wheel-specific brake unit 10 via which the wheel brake cylinder 12 is hydraulically connected to the brake fluid reservoir 34. The position of the wheel outlet valve 46 is selected in such a way that, by means of the wheel outlet valve 46 present in its closed state, a transfer of brake fluid from the wheel brake cylinder 12 via the at least one return line 48 into the brake fluid reservoir 34 is prevented. If the wheel of the vehicle/motor vehicle that is braked by means of the wheel brake cylinder 12 is locked, a momentary opening of the wheel outlet valve 46 can trigger a brake fluid displacement out of wheel brake cylinder 12 via the at least one return line 48 into the brake fluid reservoir 34, whereby the locking of the wheel is released.

With respect to further features and properties of the embodiment of FIG. 3 and their advantages, reference is made to the description of FIG. 1.

All embodiments described above of the wheel-specific brake unit 10 and 10′ can be equipped with a comparatively small, cost-effective and space-saving motorized piston-cylinder device 14. A maximum receiving volume of the respective motorized piston-cylinder device 14 can be less than or equal to 8 cm³ (cubic centimeter), preferably less than or equal to 5 cm³ (cubic centimeter), in particular less than or equal to 3 cm³ (cubic centimeter). A maximum travel path of the at least one piston 18 of the motorized piston-cylinder device 14 that is adjustable by means of an operation of the electric motor 16 can also in each case be less than or equal to 80 mm (millimeter), preferably less than or equal to 60 mm (millimeter), specifically less than or equal to 40 mm (millimeter). Such a “small” design of the motorized piston-cylinder device 14 is possible since its volume is only needed for the wheel brake cylinder 12 of a single wheel. Despite the mentioned maximum receiving volume of the motorized piston-cylinder device 14 of less than or equal to 8 cm³ (cubic centimeter) and the maximum travel path of the at least one piston 18 of the motorized piston-cylinder device 14 of less than or equal to 80 mm (millimeter), a braking force exerted by the wheel brake cylinder 12 on the assigned wheel can be greater than or equal to 20 kN (kilonewton).

The comparatively “small” designability of the motorized piston-cylinder device 14 also makes the use of a relatively small and comparatively cost-effective electric motor 16 possible. A maximum torque that can at most be achieved by means of the electric motor 16 can therefore be less than or equal to 2 Nm (newton-meter), for example less than or equal to 1.5 Nm (newton-meter), in particular less than or equal to 1 Nm (newton-meter). The electric motor 16 can optionally be a DC motor or an EC motor. Comparatively cost-effective materials, such as plastic, can also be used for the threaded device 20.

In addition, all wheel-specific brake units 10 and 10′ described above have a simple design, which is why they are cost-effective to manufacture and easy to miniaturize. Furthermore, all wheel-specific brake units 10 and 10′ described above, or the brake systems equipped therewith, can be mounted with a relatively low amount of work on a vehicle/motor vehicle.

FIG. 4 shows a flowchart for explaining an embodiment of the method for mounting a wheel-specific brake unit on a vehicle.

It is expressly pointed out that feasibility of the method described below is not limited to a specific vehicle type/motor vehicle type of the vehicle/motor vehicle on which the wheel-specific brake unit is mounted.

All wheel-specific brake units described above can be mounted on the particular vehicle by means of the method described below. However, feasibility of the method is not limited to mounting one of the embodiments explained above of wheel-specific brake units on the particular vehicle.

In a method step S1, the wheel brake cylinder of the wheel-specific brake unit is mounted on a wheel of the vehicle. The method step S1 can be performed such that, after the mounting of the wheel-specific brake unit has been completed, the wheel can be braked by means of a brake pressure build-up in the wheel brake cylinder mounted thereon.

A method step S2 is also performed before, after or simultaneously with the method step S1. In the method step S2, the motorized piston-cylinder device of the (same) wheel-specific brake unit is mounted on a spring-loaded region of the vehicle with respect to the wheel. This ensures that the motorized piston-cylinder device is protected from environmental influences, such as impacts, splash water and a hot brake disk of the wheel, during the operation of the wheel-specific brake unit. Preferably, the motorized piston-cylinder device is mounted on a spring-loaded mass (sprung mass).

After the mounting of the wheel-specific brake unit has been brought about by means of the method steps S1 and S2, damage to the motorized piston-cylinder device during the operation of the wheel-specific brake unit is hardly to be feared. Therefore, there are also hardly any repair costs for the wheel-specific brake unit mounted by means of the method steps S1 and S2. The method described here can also be performed with a relatively low amount of work.

1-11. (canceled)

12. A wheel-specific brake unit for a vehicle, comprising:
a single wheel brake cylinder;
a motorized piston-cylinder device with an electric motor and at least one piston adjustable by an operation of the electric motor; and
at least one hydraulic line via which the wheel brake cylinder is hydraulically connected to the motorized piston-cylinder device in such a way that brake fluid is transferable between the motorized piston-cylinder device and the wheel brake cylinder using the at least one adjusted piston of the motorized piston-cylinder device.

13. The wheel-specific brake unit according to claim 12, wherein a maximum receiving volume of the motorized piston-cylinder device is less than or equal to 8 cm³.

14. The wheel-specific brake unit according to claim 12, wherein a maximum travel path of the at least one piston of the motorized piston-cylinder device that is adjustable by the operation of the electric motor is in each case less than or equal to 80 mm.

15. The wheel-specific brake unit according to claim 12, wherein the wheel-specific brake unit further comprises a printed circuit board configured and/or programmed to control the operation of the electric motor arranged at and/or on the printed circuit board.

16. The wheel-specific brake unit according to claim 12, wherein the wheel-specific brake unit further comprises a wheel inlet valve arranged in the at least one hydraulic line in such a way that, via the wheel inlet valve present in its closed state, a transfer of brake fluid from the motorized piston-cylinder device into the wheel brake cylinder is prevented.

17. The wheel-specific brake unit according to claim 12, wherein the wheel-specific brake unit further comprises a brake fluid reservoir, and the motorized piston-cylinder device is hydraulically connected to the brake fluid reservoir in such a way that brake fluid from the brake fluid reservoir can be sucked into the motorized piston-cylinder device.

18. The wheel-specific brake unit according to claim 17, wherein the wheel-specific brake unit further comprises a wheel outlet valve arranged in at least one return line in such a way that, via the wheel outlet valve present in its closed state, a transfer of brake fluid from the wheel brake cylinder via the at least one return line into the brake fluid reservoir is prevented.

19. A brake system for a vehicle, comprising:
at least one wheel-specific brake unit each including:
a single wheel brake cylinder,
a motorized piston-cylinder device with an electric motor and at least one piston adjustable by an operation of the electric motor, and
at least one hydraulic line via which the wheel brake cylinder is hydraulically connected to the motorized piston-cylinder device in such a way that brake fluid is transferable between the motorized piston-cylinder device and the wheel brake cylinder using the at least one adjusted piston of the motorized piston-cylinder device.

20. The brake system according to claim 19, further comprising a control device, to which the at least one wheel-specific brake unit is electrically connected, configured and/or programmed, by taking into account at least one braking request signal provided to the control device by at least one brake actuation element sensor and/or by at least one vehicle speed control mechanism, to output at least one control signal to the electric motor or to a respective printed circuit board of the at least one wheel-specific brake unit.

21. The brake system according to claim 19, wherein the brake system wherein the at least one wheel-specific break unit includes a plurality of wheel-specific brake units, wherein each of the wheel-specific brake units is hydraulically separate from the at least one other wheel-specific brake unit.

22. A method for mounting a wheel-specific brake unit on a vehicle, the wheel-specific brake unit including:
a single wheel brake cylinder,
a motorized piston-cylinder device with an electric motor and at least one piston adjustable by an operation of the electric motor, and
at least one hydraulic line via which the wheel brake cylinder is hydraulically connected to the motorized piston-cylinder device in such a way that brake fluid is transferable between the motorized piston-cylinder device and the wheel brake cylinder using the at least one adjusted piston of the motorized piston-cylinder device,
wherein the method comprises the following steps:
mounting the wheel brake cylinder of the wheel-specific brake unit on a wheel of the vehicle; and
mounting the motorized piston-cylinder device of the wheel-specific brake unit on a spring-loaded region of the vehicle with respect to the wheel.
